(19) United States
(12) Patent Application Publication
(10) Pub. No.: US 2015/0313080 A1
(43) Pub. Date: Nov. 5, 2015

(54) Unloading Configuration for Grain Tank on an Agricultural Harvester

(71) Applicant: TRIBINE INDUSTRIES LLC, Logansport, IN (US)

(72) Inventors: Robert A. Matousek, Valley Center, KS (US); Thomas Klenke, Spearville, KS (US); Reinhold Anthony Herrman, Manhattan, KS (US)

(73) Assignee: Tribine Industries LLC, Logansport, IN (US)

(21) Appl. No.: 14/650,893

(22) PCT Filed: Jan. 23, 2014
(86) PCT No.: PCT/US14/12743

§ 371 Date: Jun. 10, 2015

Related U.S. Application Data
(60) Provisional application No. 61/756,334, filed on Jan. 24, 2013.
(60) Provisional application No. 61/756,337, filed on Jan. 24, 2013.

(51) Int. Cl. A01D 41/12; B65G 67/24; A01D 61/00

(52) U.S. Cl. CPC A01D 41/1217; A01D 61/008; B65G 67/24; B65G 2201/042; B65G 2814/0326

(57) ABSTRACT

Disclosed is an improved articulated combine of a forward grainhead carried by a forward bogey devoid of grain storage and operated by an operator and a rear grain storage bogey. The rear bogey carries a grain unload arm. A diagonal grain auger assembly is disposed within the rear bogey and transfers grain from at least the front area of the rear bogey into the grain unload arm. A grain unload arm assembly is carried by the rear bogey and is composed of a moveable upper grain unload arm and a fixed lower grain unload arm whose proximal end is at a corner of the rear bogey, not at the center which lowers the angle, and which is connected by a slew bearing assembly matable to a rack for rotating. A grain unload auger is disposed within each of the upper grain unload arm and a lower grain unload arm.

### CROSS-REFERENCE TO RELATED APPLICATIONS

This application claims benefit of U.S. Provisional Application Ser. No. 61/756,338 filed Jan. 24, 2013.

### STATEMENT REGARDING FEDERALLY SPONSORED RESEARCH

Not applicable.

### BACKGROUND

The present disclosure relates to a system and method to unload grain from a grain tank on an agricultural harvester to a transport vehicle, and specifically to the use of a diagonally-disposed drag auger and gravity sump for more evenly unloading grain from the grain tank.

The subject of an articulated harvester, some of which are based on current commercial grain harvester designs, is disclosed in U.S. Pat. Nos. 4,317,326, 4,428,182, 6,012,272, 6,125,618, 6,339,917, 6,604,351, 6,606,844, 6,604,995, 6,604,350, 6,484,485, 6,612,101, 6,233,911, 6,240,711, 6,167,982, 7,553,228, 8,286,984, 8,292,008, and 8,435,104. A harvester/grain cart combination can be converted to an “articulated” combine as disclosed in U.S. Pat. No. 6,910,845. Various grain handling and grain unloading techniques are disclosed, inter alia, in U.S. Pat. Nos. 7,143,863 and 7,198,449. The disclosures of these patents are expressly incorporated herein by reference.

Most of the articulated combines cited above exhibit compromised design features due to the design basis being limited to current commercial grain harvester designs. For example, current commercial grain harvester designs have an onboard grain bin with the forward bogey along with grain heads, cleaners, etc. That does not make such designs faulty, as they represent a substantial advancement in the harvester art for manufactures that want to maintain current grain harvester architecture.

Current features for today's agricultural harvesters can be based on features disclosed in U.S. Pat. Nos. 8,286,984, 8,292,008, and 8,435,104.

The presently disclosed articulated combine is based on obtaining more even grain outflow from the grain bin, provision for a side-discharge chaff spreader assembly, a unique unloading arm assembly, and additional features disclosed herein.

### BRIEF SUMMARY

Disclosed is an improved articulated combine of a forward grainhead carried by a forward bogey devoid of grain storage and operated by an operator and a rear grain storage bogey. The rear bogey carries a grain unload arm. A diagonal grain auger assembly is disposed within the rear bogey and transfers grain from at least the front area of the rear bogey into the grain unload arm. A grain unload arm assembly is carried by the rear bogey and is composed of a moveable upper grain unload arm and a fixed lower grain unload arm whose proximal end is at a corner of the rear bogey, not at the center which lowers the angle, and which is connected by a slew bearing assembly matable to a rack for rotating. A grain unload auger is disposed within each of the upper grain unload arm and a lower grain unload arm.

The moveable upper unload arm assembly is lifted from a storage position and rotates via the slew bearing assembly to mate with the lower fixed grain unload arm assembly.

### BRIEF DESCRIPTION OF THE DRAWINGS

For a fuller understanding of the nature and advantages of the present method and process, reference should be had to the following detailed description taken in connection with the accompanying drawings, in which:

FIG. 1 is an overhead view of the disclosed articulated harvester and a grain hauling semi vehicle with the rear harvester bogey crabbed for unloading grain into the grain hauling semi vehicle and showing the proximity sensors and cameras carried by the disclosed harvester;

FIG. 2 is a rear view of the disclosed harvester and a grain hauling semi vehicle of FIG. 1;

FIG. 3 is a side view of the rear bogey of the harvester of FIG. 1 with the unload arm in a folded, storage position; and

FIG. 4 is an exploded cut-away view of the elbow joint of the unload arm shown in FIG. 2;

FIG. 5 is a side view of the rear bogey of FIG. 3 with the unload arm in an unfolded, grain discharge position;

FIG. 6 is a front view of the rear bogey of FIG. 3 with the unload arm in an unfolded, grain discharge position;

FIG. 7 is a top view of the rear bogey of FIG. 3;

FIG. 8 is a sectional view along line 8-8 of FIG. 3;

FIG. 9 is a front view of the rear bogey of FIG. 3 with the front wall of the rear bogey partially cut away;

FIG. 10 is a rear view of the rear bogey of FIG. 3 with the unload arm in a folded, grain storage position;

FIG. 11 is a sectional view taken along line 11-11 of FIG. 7;

FIG. 12 is an exploded cut-away view of the discharge end of the diagonal drag auger in the grain bin of the rear bogey of FIG. 11;

FIG. 13 is a sectional view taken along line 13-13 of FIG. 7; and

FIG. 14 is a sectional view taken along line 14-14 of FIG. 7.

The drawings will be described in greater detail below.

### DETAILED DESCRIPTION

The articulated agricultural harvester or combine (these terms being synonymous and used interchangeably) in the drawings is a Tribine™ harvester (Tribine Industries LLC, Logansport, Ind.) having a grain bin capacity of 1,000 bushels of clean grain and unloads the clean grain at a rate of 500 bushels per minute. Normal grain removal from an elevated grain bin uses an unload auger running from the back to the front of the grain bin for transferring grain to the unload arm assembly. When grain is unloaded from the grain bin in this fashion, grain preferentially is removed from the rear of the grain bin; thus, leaving the remaining grain in the front of the grain bin. This can cause weight on the tongue (articulation joint) to increase from near zero to around 8,600 lbs. The disclosed diagonal drag auger evens out grain removal so that the grain is removed fairly uniformly from the front as well as the rear of the grain bin; thus, not placing any significant increase on the tongue.

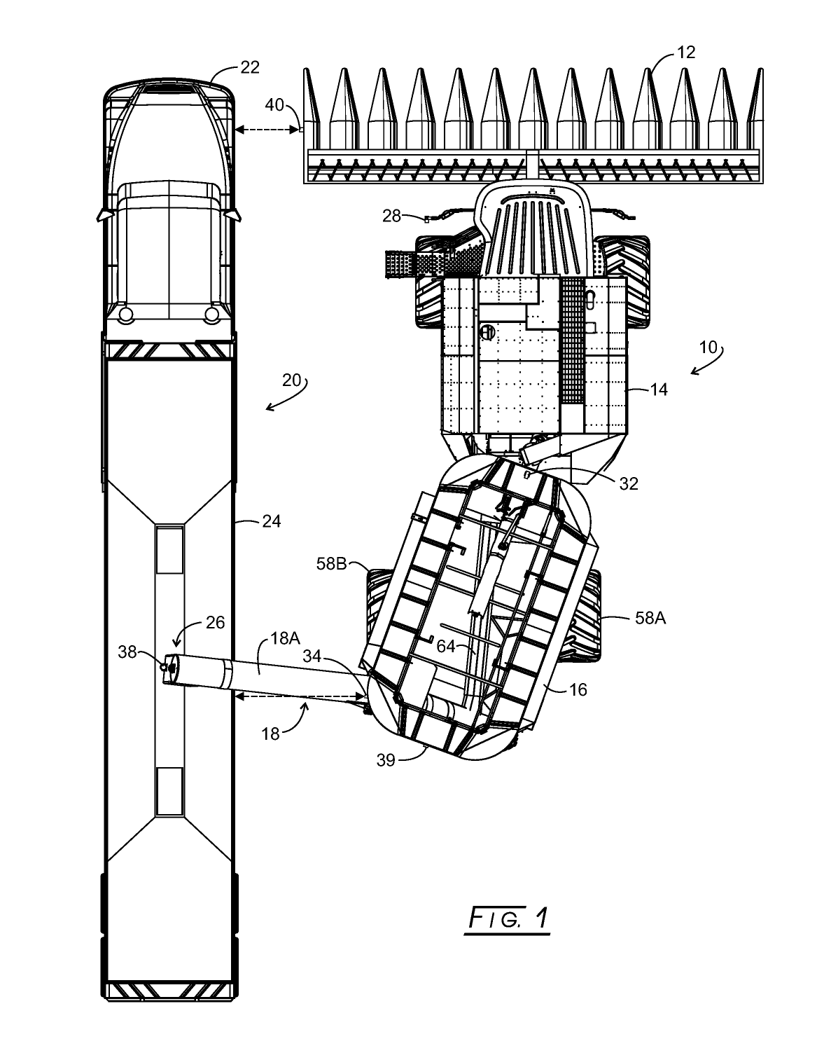

Referring now to FIG. 1, an articulated harvester, combine, or harvesting combine, 10, is fitted with a 16-row cornhead, 12, and consists of a forward bogey, 14, and rear bogey, 16. While combine 10 is fitted with wheels, it could be a tracked combine. Forward bogey 14 is fitted with an operator cab, engine, grain cleaning and handling, and similar capability, but for grain storage, which it is devoid of. Instead, rear bogey 16 is fitted with a grain bin and unloading capability, for example, a grain-unloading arm, 18, housing a conveyor (e.g., a screw conveyor), such as is described in commonly-owned U.S. Pat. No. 8,286,984.

Adjacent to combine 10 is a grain hauling vehicle, 20, consisting of a forward cab with engine, 22, towing a grain trailer, 24, capable of holding 1,000 bushels of clean grain. Such vehicle also could be a grain cart, gravity wagon, or other grain storage vehicle. As is typical for modern day combines, combine 10 unloads its clean grain from rear bogey 16 while the combine is in the field harvesting grain; thus, the need to unload its grain bin very rapidly. In order to accomplish this grain unloading, vehicle 20 is parked next to combine 10 and combine 10 moves over adjacent to semi vehicle 20. Rear bogey 16 then can be crabbed to move its unloading arm 18 to a position such that the discharge end, 26, is centered over grain trailer 24 and clean grain unloading proceeds. Since the combine operator needs to steer combine 10 while simultaneously pulling over close to vehicle 20 and crabbing rear bogey 16, anything to aid the combine operator in knowing precisely where forward bogey 14 and rear bogey 16 are relative to grain hauling semi vehicle 20 would be greatly appreciated by the combine operator.

In order to give this additional position information to the combine operator in rear time, forward bogey 14 is fitting with cameras, 28, on its unload left side and optionally on its right side. Rear bogey 14 also is fitted with camera, 32, at its upper front center looking into the grain storage bin. Each of these cameras feeds a video image to the combine operator so he can see grain hauling semi vehicle disclosed harvester and a grain-hauling vehicle 20.

Rear bogey 16 also is fitted with a proximity sensor, 34, at its left rear. Discharge end 26 of grain unloading arm 18 also is fitted with a camera, 38. An additional camera, 39, is carried by rear bogey 16 at its upper rear. Finally cornhead 12 is fitted with a proximity sensor, 40 at its left side. All proximity sensors also feed their data to the combine operator. For example, the cameras may be Agcam cameras (Dakota Micro, Inc., Cayuga, N. Dak.) and the sensors may be Senix TSPC-155 ultrasonic distance sensors (Senix Corporation, Hinesburg, Vt.). Harvesting combine 10 unloads clean grain only on its left side in the embodiment in the drawings. It will be recognized that the cameras and sensors could be located only on the right side for unloading clean grain on the right side or located on both sides for providing unloading of clean grain on both sides. The use of such proximity sensors and cameras is disclosed in commonly-owned application identified by Attorney Docket No. DIL2015PC, filed on even date herewith.

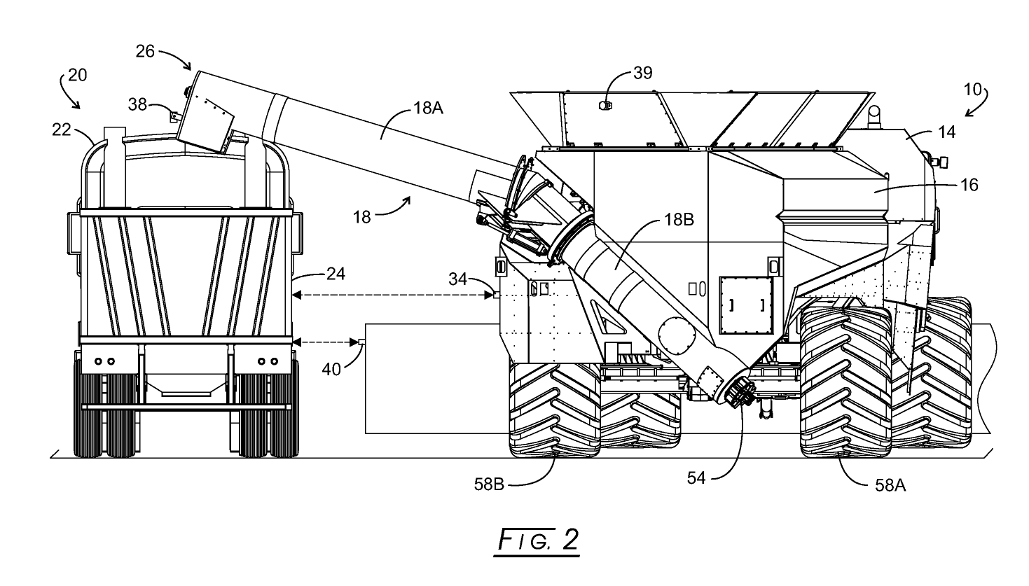

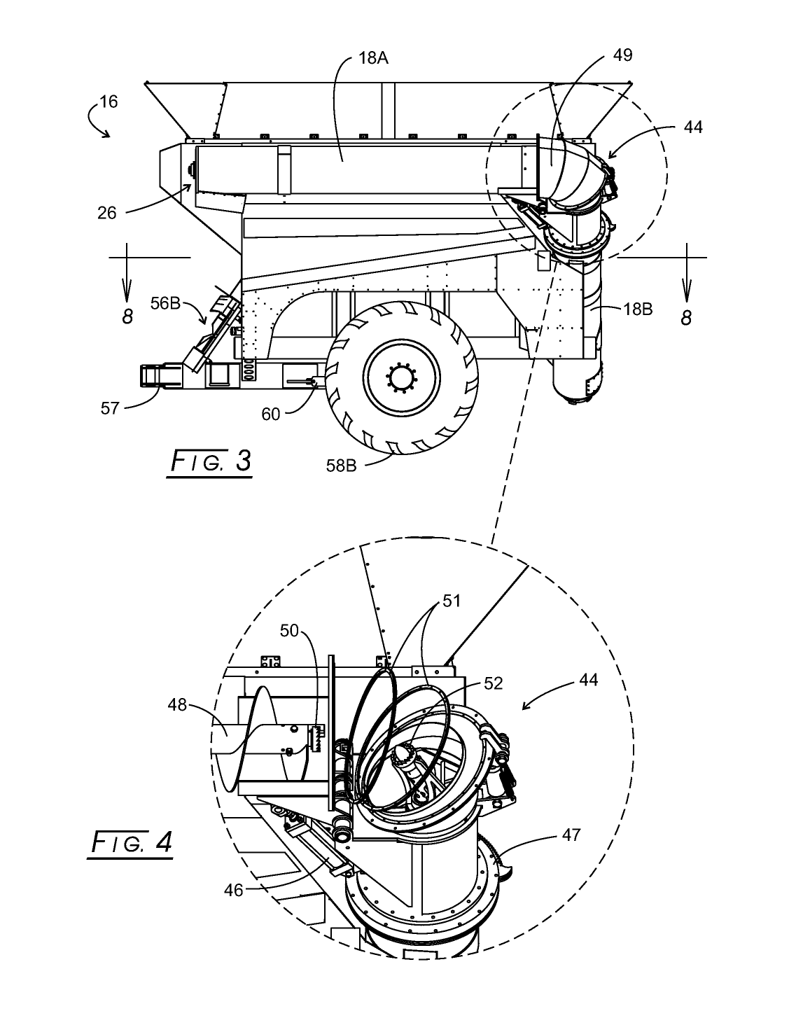

Referring now also to FIG. 3, unloading arm is seen to consist of a moveable upper section, 18A, and a fixed lower section, 18B, connected by a slew bearing assembly, 44, seen in an exploded view in FIG. 4 wherein bellows, 49, has been removed. The slew bearings rotate against a rack assembly, 47, when unloading arm 18A is raised by a cylinder assembly, 46 (see FIG. 2), with rotation of upper unload arm 18A powered by a rotation hydraulic motor, 49 (see FIG. 5). Thus, upper unload arm 18A must be both lifted up and rotated to mate with lower unload arm 18B. Slew bearings, collectively, 51, rotate against rack assembly 47 when upper unload arm 18A rotates after being lifted into position. Importantly, the upper end of fixed lower unloading arm 18B is fixed at an upper corner of rear bogey 16. Moveable upper unload arm assembly 18A is lifted from a storage position and rotates via slew bearing assembly 44 to mate with the lower fixed grain unload arm assembly 18B.

An auger, 48 (FIG. 4), disposed in upper unloading arm 18A has a bearing, 50, at its lower end that seats against a bearing, 52, disposed at the upper end of an auger, 68 (see FIG. 14), inside lower unloading arm 18B. Thus, power supplied by motor 54 (see FIG. 2), to the unseen auger in lower unloading arm 18B transfers its rotation to auger 48 in upper unloading arm 18A for unloading of grain.

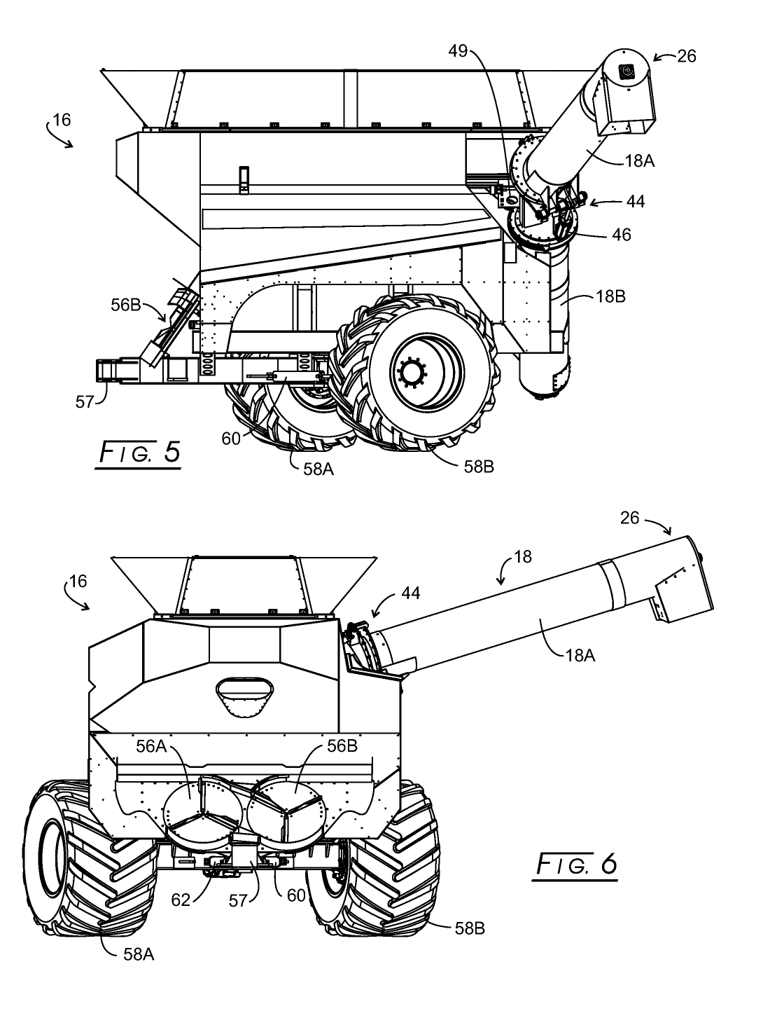

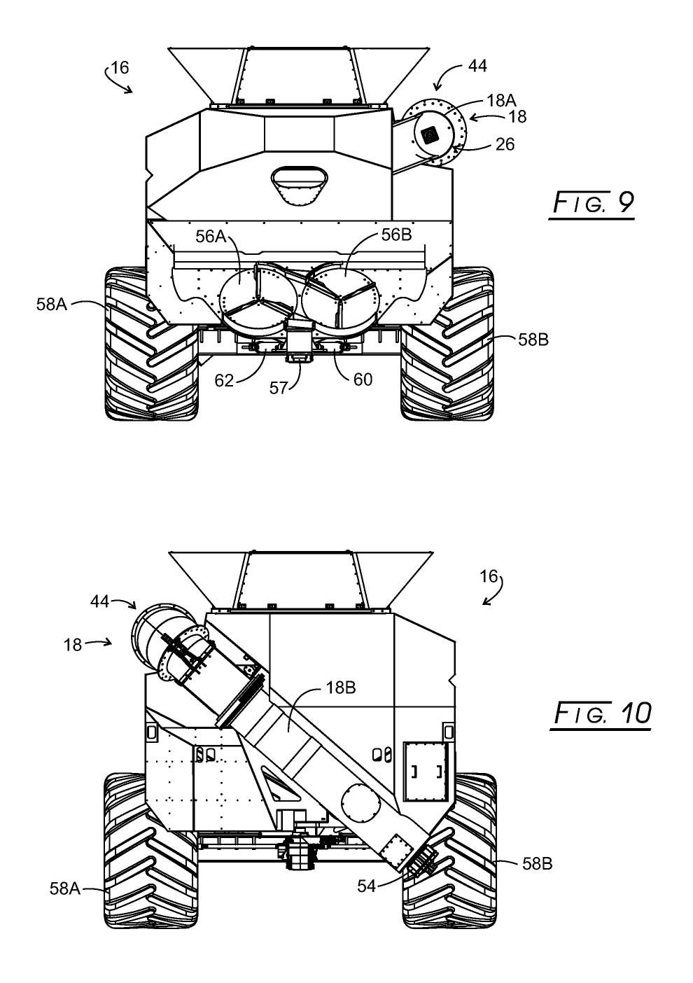

FIGS. 5 and 6 show unload arm 18 is an extended position for unloading of grain from rear bogey 16 in which harvested grain is stored. Chaff spreaders, 56A and 56B, receive chaff from forward bogey 14 and distribute the chaff sideways from the direction of travel of harvesting combine 10. Wheels, 58A and 58B, are turned to the side, as rear bogey 14 is in a crabbed position for unloading of grain (see FIG. 1). A tongue, 57, is connected to an articulation joint assembly, not specifically seen in the drawings. Articulation cylinders, 60 and 62 (see FIG. 9 also), are part of the articulation joint assembly, as more fully described in the commonly-owned patents cited above. FIGS. 9 and 10 show rear bogey 16 with unload arm assembly 18 in a stowed position.

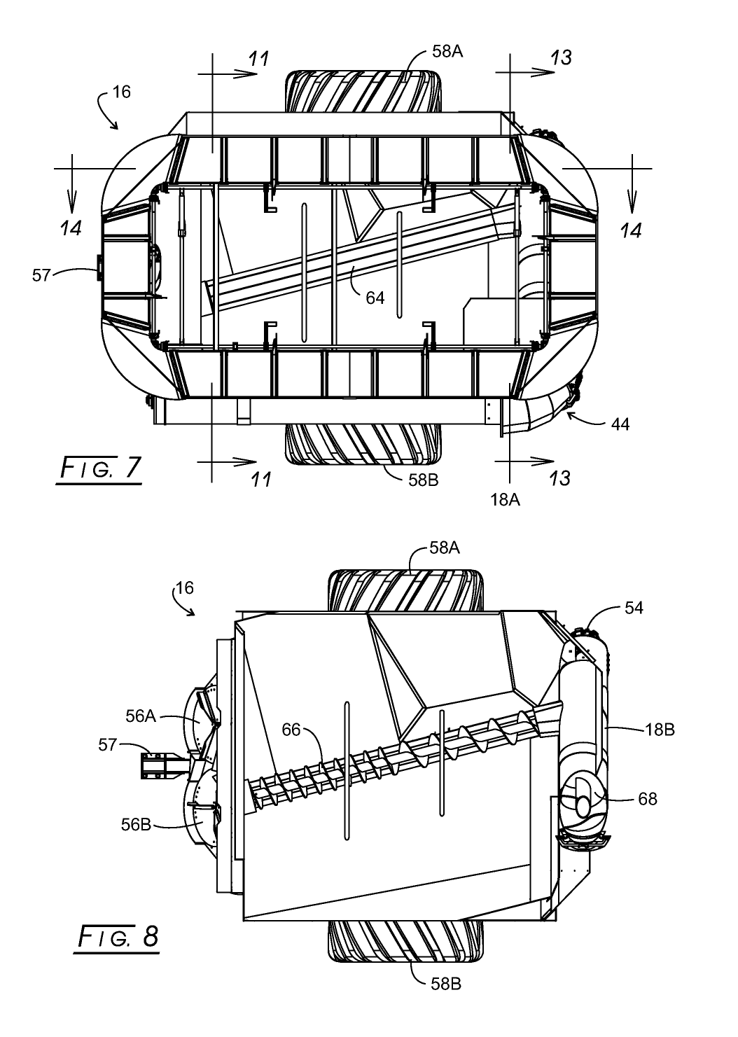

Referring now to FIGS. 7 and 8, rear bogey 16 is seen from above to reveal diagonal grain movement auger assembly with a fixed upper cover or hogback, 64, in position in FIG. 7 and removed in FIG. 8 to reveal diagonal drag auger, 66. Hogback 64 covers the top and upper sides of diagonal drag auger 66; thus, permitting grain to enter diagonal drag auger 66 at the lower side areas.

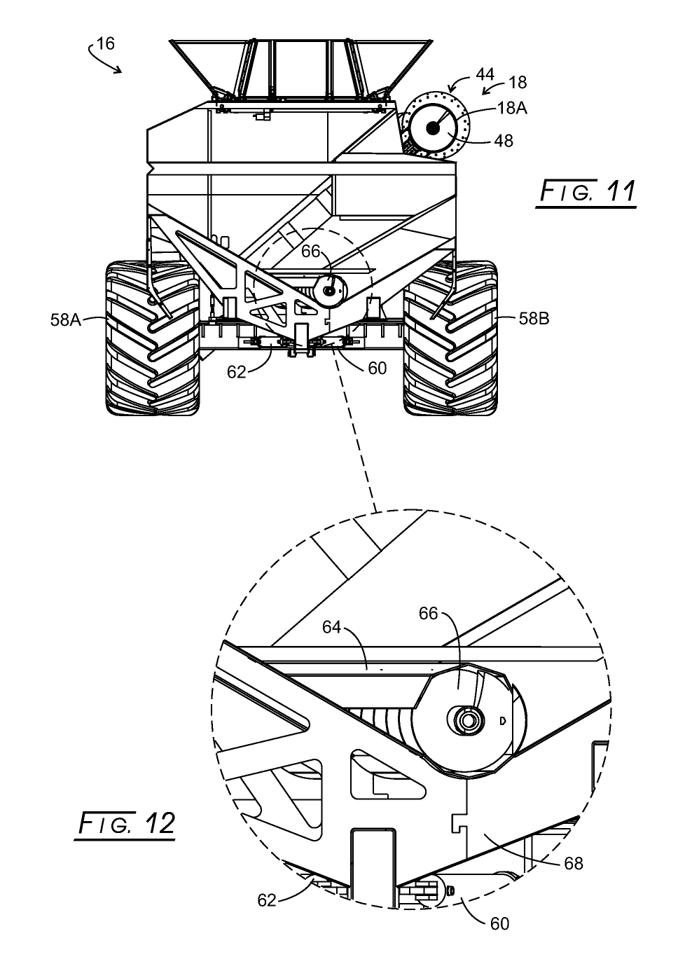

Diagonal auger 66 draws grain from the front of rear bogey 16 to even out grain removal both front and back. The front pitch of diagonal auger 66 is closer together and the pitch opens up or widens towards the rear. The close pitch will only hold so much grain. When the pitch widens, diagonal drag auger 66 picks up more grain; thus, an even discharge of grain front to back. If the pitch were the same all along diagonal auger 66, the grain bin would empty from the front first because the auger pitches would be full; rather, then a more even emptying of grain front to back. The auger in lower unload arm 18B also draws grain from a sump (lowest area in rear bogey 16) at the rear of rear bogey 16. Thus, rear bogey 16 grain removal system consists of the sump auger that draws grain from the rear are of the grain bin and diagonal drag auger 66 that draws grain from the front area of the grain bin; thus, resulting in even grain removal from the grain bin carried by rear bogey 16. A framework assembly, 68, supports auger 66, as seen in FIGS. 11 and 12.

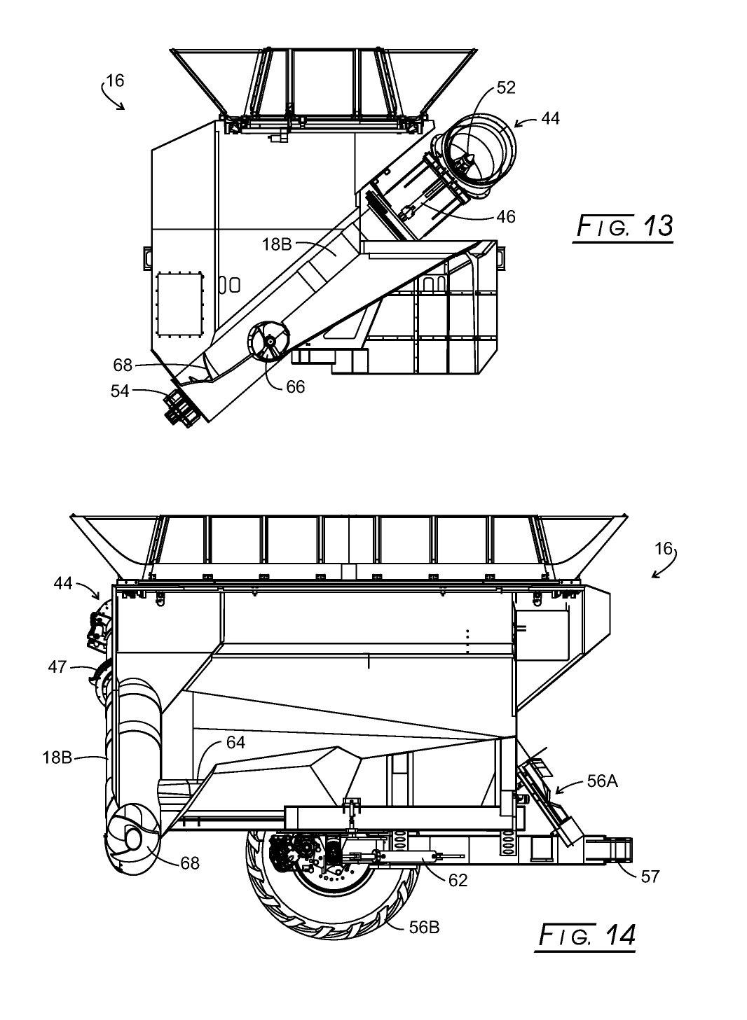

Referring now to FIG. 13, the connection of auger 66 or port into lower unload arm 18B is seen. In FIG. 14, much of the underside of rear bogey 16 is revealed.

While the apparatus and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. An improved articulated combine of a forward grainhead carried by a forward bogey devoid of grain storage and operated by an operator and a rear grain storage bogey, the rear bogey carrying a grain unload arm, the improvement comprising:
(a) a diagonal grain auger assembly disposed within said rear bogey and transferring grain from at least the front area of the rear bogey into the grain unload arm; and
(b) a sump grain auger assembly disposed within said rear bogey and transferring grain from at least the rear area of the rear bogey into the grain unload arm.

2. The improved articulated combine of claim 1, wherein said diagonal grain auger assembly includes an auger covered by a fixed hogback cover.

3. The improved articulated combine of claim 1, wherein said diagonal grain auger assembly transfers grain in the rear bogey to a grain unload arm assembly carried by and located at the rear of the rear bogey.

4. An improved articulated combine of a forward grainhead carried by a forward bogey devoid of grain storage and operated by an operator and a rear grain storage bogey, the rear bogey carrying a grain unload arm, the improvement comprising:
(b) a grain unload arm assembly carried by the rear bogey and composed of a movable upper grain unload arm section and a fixed lower grain unload arm section whose upper end is fixed at a rear corner of the rear bogey grain tank, the moveable upper unload arm movable upwardly and rotating to connect to the fixed lower grain unload arm by a slew bearing assembly matable to a rack, a grain unload auger disposed within each of the upper grain unload arm section and a lower grain unload arm section.

5. The improved articulated combine of claim 4, wherein in its storage position, the upper grain unload arm is folded against the side of the rear bogey and the lower grain unload arm is located at the rear of the rear bogey.

6. An improved articulated combine of a forward grainhead carried by a forward bogey devoid of grain storage and operated by an operator and a rear grain storage bogey, the rear bogey carrying a grain unload arm, the improvement comprising:
(a) a diagonal grain auger assembly disposed within said rear bogey and transferring grain from at least the front area of the rear bogey into the grain unload arm; and
(b) a grain unload arm assembly carried by the rear bogey and composed of an upper grain unload arm and a lower grain unload arm connected by a slew bearing assembly matable to a rack, a grain unload auger disposed within each of the upper grain unload arm and a lower grain unload arm.

7. The improved articulated combine of claim 6, wherein said diagonal grain auger assembly includes an auger covered by a fixed hogback cover.

8. The improved articulated combine of claim 6, wherein said diagonal grain auger assembly transfers grain in the rear bogey to a grain unload arm assembly carried by and located at the rear of the rear bogey.

9. The improved articulated combine of claim 6, wherein in its storage position, the upper grain unload arm is folded against the side of the rear bogey and the lower grain unload arm is located at the rear of the rear bogey.

10. The improved articulated combine of claim 6, wherein said rear bogey also is fitted with a gravity fed lower sump that also feeds grain into said grain unload arm assembly.

11. An improved articulated combine of a forward grainhead carried by a forward bogey devoid of grain storage and operated by an operator and a rear grain storage bogey, the rear bogey carrying a grain unload arm, the improvement comprising: chaff spreaders carried at the front of the rear bogey and distributing chaff received from the forward bogey to the side of the direction of travel of the articulated combine.

12. The improved articulated combine of claim 11, wherein chaff is distributed to both sides of the articulated combine.
